(19) United States
(12) Patent Application Publication
(10) Pub. No.: US 2010/0302152 A1
(43) Pub. Date: Dec. 2, 2010

(54) DATA PROCESSING DEVICE

(75) Inventor: Takayuki KIRIGAYA, Saitama-ken (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/723,889

(22) Filed: Mar. 15, 2010

(30) Foreign Application Priority Data
May 26, 2009 (JP) 2009-126927

(51) Int. Cl. G09G 5/08

(52) U.S. Cl. 345/158

(57) ABSTRACT

A data processing device having a display unit, a position sensor unit and an input control unit is provided. The display unit displays an option for operation. The position sensor unit detects an orientation of a linearly shaped pointer put in a front space of a screen of the display unit, and detects a position of a tip of the pointer. The input control unit identifies, upon the position sensor unit detecting the tip of the pointer as being in front of the option displayed on the screen of the display unit, the option as being selected. The input control unit displays the selected option in a form different from a form in which another option is displayed. The input control unit scrolls, upon the position sensor unit detecting a change of the orientation of the pointer, content displayed on the screen of the display unit.

### CROSS REFERENCE TO RELATED APPLICATIONS

This application is based upon and claims the benefit of priority from the prior Japanese Patent Application No. 2009-126927 filed on May 26, 2009;

the entire contents of which are incorporated herein by reference.

### BACKGROUND

1. Field

Embodiments of this disclosure relates to a data process ing device.

2. Description of the Related Art

Input and output methods for transferring data between a data processing device such as a mobile communication device or a PDA and a user through a touchscreen are known. If a pointer touches a touchscreen on which an X-Y coordinate system is formed, a device having the touchscreen can obtain the X-Y coordinates of a position where the pointer touches the touchscreen. The device displays options such as menu items on the touchscreen, and performs a process supposing that a menu item displayed on the position where the pointer has touched is selected. The pointer can be a stylus pen, a finger and so on.

Further, a process is known such that the device obtains the Z-coordinate of the pointer that is a distance between the pointer and the touchscreen in addition to the X-Y coordinates closest to the pointer if the pointer is close to the touchscreen. The X-Y-Z coordinates can be obtained by means of a touchscreen of an electrostatic capacitance system. Further, if a stylus pen emits electromagnetic waves such as infrared rays from its tip in a conical directivity and a detecting layer provided on the touchscreen receives the electromagnetic waves, the X-Y-Z coordinates can be obtained depending upon how intensely and at which X-Y coordinates the electromagnetic waves are received.

If the tip of the pointer is closer to the touchscreen (i.e., the Z-coordinate value is smaller) and the X-Y-Z coordinates of the tip are detected as described above, the menu item displayed on the X-Y coordinates can be enlarged even if the tip of the pointer does not touch the touchscreen. Further, if the Z-coordinate value is smaller than a certain threshold, the menu item can be identified as being selected for process continuation, as disclosed in, e.g., Japanese Patent Publication of Unexamined Applications (Kokai), No. 2005-529395.

Further, a process performed by means of a device for which a position on a tablet of a stylus tip is used for input operations is known such that the stylus tip moves along a groove provided on a housing and inclines and that displayed content scrolls in accordance with the position of the tip and the inclination. The stylus tip is provided with a resonant circuit and the housing is provided with a loop coil along the groove for detecting the position and the inclination. Hence, a voltage is induced in the resonant circuit by means of an electromagnetic wave transmitted from the loop coil, and then, the loop coil senses an electromagnetic wave emitted by the resonant circuit by means of the induced voltage, as disclosed in, e.g., Japanese Patent Publication of Unexamined Applications (Kokai), No. 2004-206613.

According to the method disclosed in JP-A-2005-529395, the X-Y-Z coordinates of the pointer tip can be detected, but a change of the X-Y coordinates is treated similarly as a change of the X-Y coordinates of the pointer tip being in contact with the touch-screen. Thus, there is a problem in that it is disregarded that the pointer moves in a 3D space. This problem clearly appears in that, e.g., operation for scrolling data displayed on the touchscreen is not enhanced.

Meanwhile, the method disclosed in JP-A-2004-206613 has a problem in that it is not suitable for performing an operation other than scrolling the displayed content together. That is, it is necessary for the stylus to move to the groove for scrolling and to leave the groove and move onto the tablet for other operations. A user needs a bothering operation of moving the stylus back and forth between the groove and the tablet.

### SUMMARY

Exemplary embodiments of the invention provides a data processing device which comprises a display unit which displays menu items, a position sensor unit which detects an orientation of a pointer and a position of the pointer, and an input control unit which identifies, upon the position sensor unit detecting the position of the pointer, one of the menu items as being selected, changes the selected menu item in display form, and scrolls the menu items displayed on the display unit when the position sensor unit detects the movement of the position of the pointer.

### BRIEF DESCRIPTION OF THE DRAWINGS

FIG. 1 shows an external view of a mobile communication device.

FIG. 2 is a block diagram showing a configuration of the mobile communication device.

FIG. 3 is a flowchart of an operation for extracting a command of a stylus command extracting function.

FIG. 4 shows a first example of display scrolling of the mobile communication device.

FIG. 5 shows a second example of display scrolling of the mobile communication device.

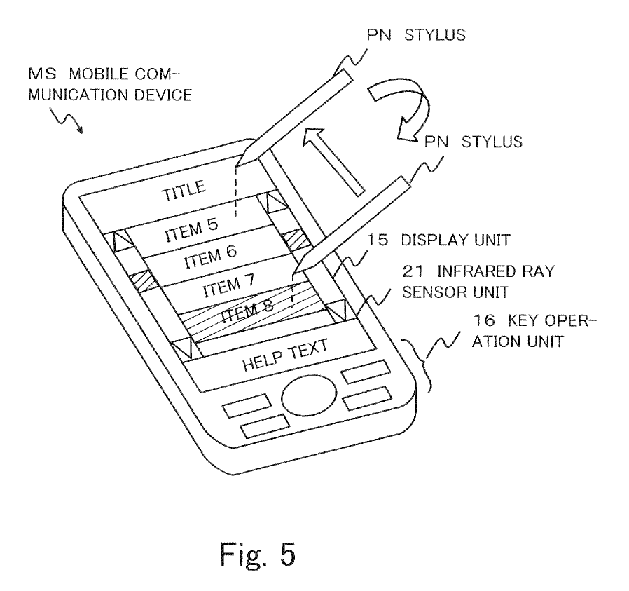

FIG. 6 shows a third example of display scrolling of the mobile communication device.

FIG. 7 shows a fourth example of display scrolling of the mobile communication device.

### DETAILED DESCRIPTION

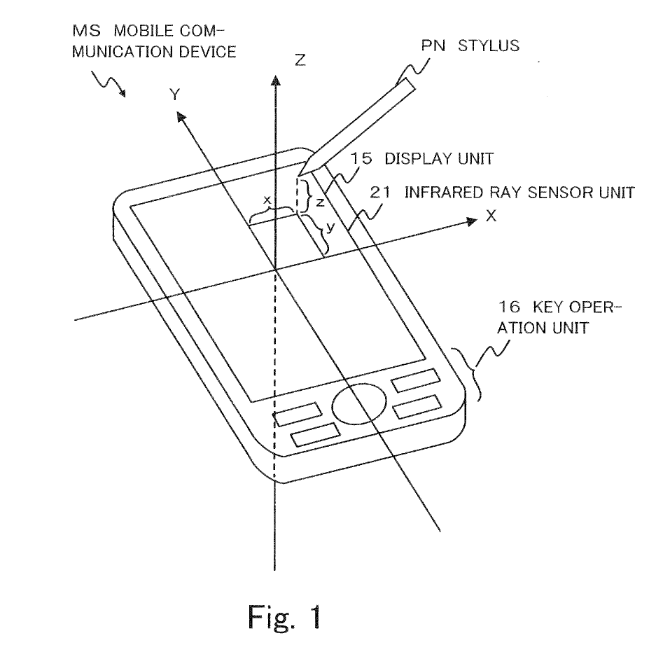

An example of a mobile communication device to which a data processing device of an embodiment of the present invention is applied will be explained hereafter with reference to the drawings. FIG. 1 shows an external view of a mobile communication device MS. The mobile communication device MS is provided with a display unit 15 and a key operation unit 16 on a front face.

Positions on a screen of the display unit 15 and on the outside of the screen on a surface of a housing of the mobile communication device MS can be identified by means of x-y coordinates on a horizontal X-axis for which a right side of the screen is a positive side and on a vertical Y-axis for which an upper side of the screen is a positive side. Further, a distance from the screen can be identified by means of a z-coordinate on a Z-axis perpendicular to the screen on which a front side of the screen is a positive side. A position in a front space of the screen can thereby be identified by means of the x-y-z coordinates.

The mobile communication device MS is provided with an infrared ray sensor unit 21 in such a way that at least the screen of the display unit 15 is covered by the infrared ray sensor unit 21 and, more preferably, that the infrared ray sensor unit 21 reaches the outside of the screen on the housing of the mobile communication device MS. The infrared ray sensor unit 21 detects infrared ray intensities at a plurality of positions, i.e., for every plural x-y coordinates.

Incidentally, the mobile communication device MS may be provided with a touch sensor in such a way that the screen of the display unit 15 is totally or partially covered by the touch sensor. If a pointer touches a surface of the touch sensor, the touch sensor senses the touch and detects x-y coordinates of the touched position.

The key operation unit 16 is constituted by, e.g., function keys to be used for instructing the mobile communication device MS to be powered on and off and so on.

An approximately linearly shaped stylus PN emits infrared rays from a tip in a direction in which the stylus PN extends in a conical directivity. A user of the mobile communication device MS holds the stylus PN in such a way that the tip is directed towards the screen of the display unit 15. Thus, x-y-z coordinates of the tip and an orientation of the stylus PN can be detected by means of the infrared ray intensities detected by the infrared ray sensor unit 21 at the respective x-y coordinates. A position of the tip of the stylus PN is defined as a position of the stylus PN, hereafter.

The orientation of the stylus PN is defined here as a vector having start and end points at the tip of the stylus PN (from which the infrared rays are emitted) and at a position where the center of the infrared rays (an infrared ray emitted in a true direction of the extension of the stylus PN) reaches the infrared ray sensor unit 21, respectively. Thus, the z- and y-coordinates of the vector are negative and usually positive, respectively. If the user holds the stylus with his or her right hand and left hand, the x-coordinate of the vector is usually negative and positive, respectively.

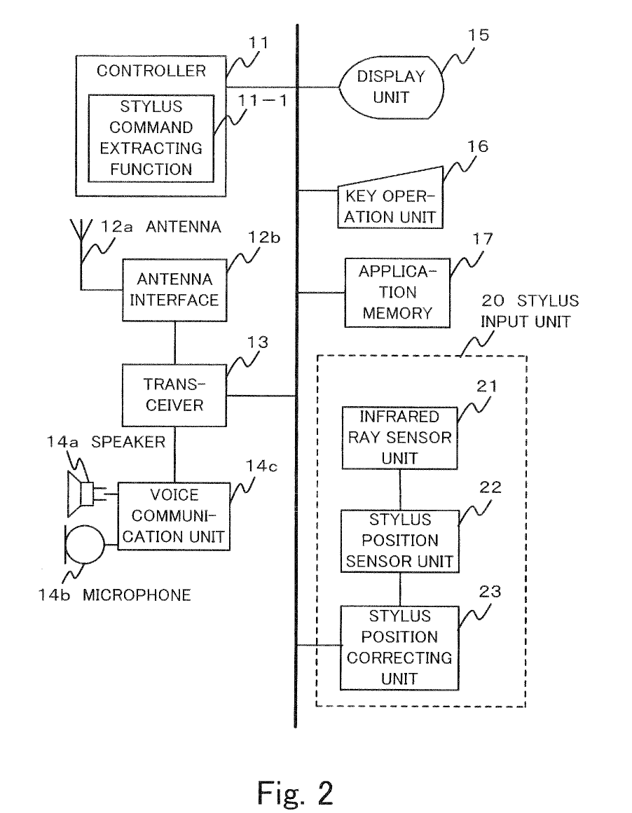

FIG. 2 is a block diagram which shows a configuration of the mobile communication device MS of the embodiment of the present invention. The mobile communication device MS is constituted by a controller 11 which controls the whole device, an antenna 12a which transmits and receives radio waves to and from a base station of a mobile communication network (not shown), an antenna interface 12b, a transceiver 13, a speaker 14a and a microphone 14b for voice communication, a voice communication unit 14c, the display unit 15, the key operation unit 16, an application memory 17 and a stylus input unit 20. The stylus input unit 20 is constituted by an infrared ray sensor unit 21, a stylus position sensor unit 22 and a stylus position correcting unit 23.

Incidentally, the controller 11 includes a stylus command extracting function 11-1 as a function related to the embodiments and implemented by means of execution of a program.

Operations of the individual portions of the mobile communication device MS configured as described above will be explained with reference to FIG. 2.

The stylus command extracting function 11-1 extracts a command for the mobile communication device MS from data indicating a position and an orientation of the stylus PN output by the stylus position correcting unit 23, and/or changes of the position and the orientation. The command is used for control of the respective portions of the mobile communication device MS similarly as an instruction entered by means of a key operation done on the key operation unit 16 is.

The antenna interface 12b provides the transceiver 13 with an RF signal received by the antenna 12a, and provides the antenna 12a with an RF signal output by the transceiver 13 to be transmitted from the antenna 12a.

The transceiver 13 amplifies, frequency-converts and demodulates the RF signal coming from the antenna interface 12b so as to obtain a digital voice signal to be provided to the voice communication unit 14c and a control signal to be provided to the controller 11. Further, the transceiver 13 modulates, frequency-converts and amplifies a digital voice signal output from the voice communication unit 14c and a control signal output from the controller 11 so as to obtain an RF signal to be provided to the antenna interface 12b.

The voice communication unit 14c converts the digital voice signal output from the transceiver 13 into an analog voice signal, amplifies the analog voice signal and provides the speaker 14a with the analog voice signal. Further, the voice communication unit 14c amplifies an analog voice signal output from the microphone 14b, converts the amplified signal into a digital voice signal and provides the transceiver 13 with the digital voice signal.

The display unit 15 is an LCD with a backlight for displaying a prompt for a user, content of user's operation, an operation state of the device, etc. The display unit 15 displays image data including letters, numerals and a cursor as controlled by the controller 11. Upon receiving an input operation through the key operation unit 16, receiving a command extracted by the stylus command extracting function 11-1, or receiving an instruction from the controller 11 in response to a call arrival signal, the display unit 15 changes displayed data.

The key operation unit 16 includes a function key for instructing the mobile communication device MS to be powered on and off. Further, the key operation unit 16 may include a plurality of function keys including a selection key for selecting a function displayed on the display unit 15 on which the cursor is placed and for directing execution of the function, a cursor shifting key and a scroll key. Further, the key operation unit 16 may include a numeral key for inputting a phone number to be called and for entering a Japanese syllabary letter (hiragana), an alphabet letter and a symbol in a toggle mode. Upon one of the keys being pressed, the key operation unit 16 informs the controller 11 of an identifier of the key.

The application memory 17 stores a plurality of applications. When the controller executes one of the applications, a screed prompting a user's input is displayed on the display unit 15. The applications run on the basis of a command extracted by the stylus command extracting function 11-1 for the display and/or a certain key operation done on the key operation unit 16. An example of the above display is a display of a menu. The menu is formed by a plurality of menu items, and prompts a user to select one of the menu items. The command and the key operation are used for selecting one of the menu items and for deciding the selection.

The applications may include a voice communication application, an email application, a directory management application, a game application and so on. The application is not limited to the application described above. Any application applies to this embodiment.

The infrared ray sensor unit 21 detects and outputs intensities of infrared rays applied to the infrared ray sensor unit 21 for the respective x-y coordinates. More preferably, the infrared ray sensor unit 21 detects and outputs the intensity as a vector represented in an x-y-z coordinate system which indicates the orientation of the stylus PN, i.e., in which direction the infrared ray is emitted. Whether the vector is detected and output or not can be set in accordance with a user's operation through the key operation unit 16 or the stylus input unit 20.

The stylus position sensor unit 22 distinguishes an area irradiated by the infrared ray emitted by the stylus PN from a non-irradiated area on the X-Y plane in accordance with the infrared ray intensities detected for the respective x-y coordinates by the infrared ray sensor unit 21. The stylus position sensor unit 22 detects the vector indicating the x-y-z coordinates of the position of the stylus PN and the orientation of the stylus PN depending on a conic section which distinguishes the irradiated and non-irradiated areas, which portion of the irradiated area is intensely irradiated and strength of a conic directivity of the infrared rays emitted by the stylus PN.

If the stylus PN and the mobile communication device MS are made as integrated with each other, an exact value of the strength of the directivity can be saved in the stylus position sensor unit 22 when the mobile communication device MS is made. If they are not integrated with each other, the stylus position sensor unit 22 can obtain the strength of the directivity by means of a key operation through the key operation unit 16. The stylus position sensor unit 22 can use a tacit value. The stylus position sensor unit 22 correctly detects the orientation of the stylus PN even without using an exact value. Further, as a distance between the position of the stylus PN and the infrared ray sensor unit 21 increases, a detected value of the z-coordinate increases. Thus, there is no significant obstacle to using the mobile communication device MS.

Incidentally, if the infrared ray sensor unit 21 detects the vector indicating in which direction the infrared rays are emitted, the stylus position sensor unit 22 can detect the x-y-z coordinates of the position of the stylus PN more exactly and more easily by referring to the vector.

Further, if the detected z-coordinate is smaller than a certain value, regard the z-coordinate as zero, i.e., regard the stylus PN as being in contact with the infrared ray sensor unit 21. As the infrared ray sensor unit 21 is so thin that a user cannot be aware of the thickness of the infrared ray sensor unit 21, suppose that the contact with the infrared ray sensor unit 21 means contact with the display screen of the display unit 15. If the z-coordinate is zero, the orientation of the stylus PN is indefinite and is not detected.

If a touch sensor is provided and x-y coordinates of a contact position of the stylus PN is detected by the touch sensor, the stylus position sensor unit 22 detects the tip of the stylus PN as being in contact with the screen of the display unit 15 at a position of the x-y coordinates and a z-coordinate being zero.

The stylus position correcting unit 23 is provided with, corrects and outputs the x-y-z coordinates of the position of the stylus PN detected by the stylus position sensor unit 22 and the vector indicating the orientation of the stylus PN. The correction is a smoothing process, here. That is, as a user of the mobile communication device MS holds the stylus PN, the stylus PN inevitably moves little by little regardless of the user's intention. Further, if the mobile communication device MS is used on a train or something, the device itself inevitably moves little by little. The stylus position correcting unit 23 removes such movements by using a low-pass filter.

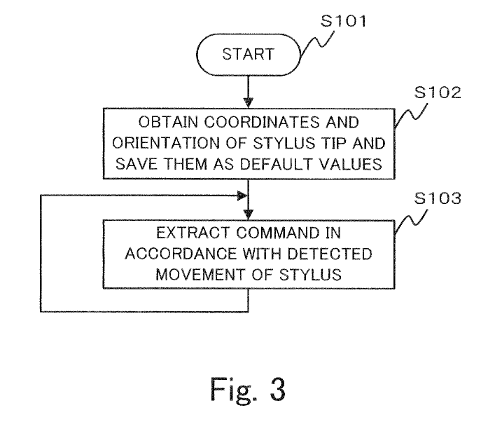

An operation of the mobile communication device MS for extracting an input command by means of the stylus command extracting function 11-1 from the x-y-z coordinates of the position of the stylus PN and the vector indicating the orientation of the stylus PN output by the stylus input unit 20 will be explained in detail with reference to a flowchart shown in FIG. 3, as follows.

The stylus command extracting function 11-1 starts to work upon the mobile communication device MS being powered on or in accordance with a certain key operation done on the key operation unit 16 (step S101). The stylus command extracting function 11-1 is provided with and saves the position of the stylus PN, i.e., the x-y-z coordinates of the position output from the stylus position correcting unit 23 and the vector indicating the orientation of the stylus PN as default values (step S102). At this time, it is identified whether the user holds the stylus PN with his or her right hand or left hand. Thus, refer to the hand that the user uses, so as to identify the movement of the stylus PN more exactly as described later.

Then, the stylus command extracting function 11-1 extracts a command according to the change of the position of the stylus PN, according to its movement in other words, so as to inform the controller 11 of the command (step S103) and to repeat the operation of the step S103. The change of the position mentioned here includes a standstill. The stylus command extracting function 11-1 stops working at any operation step upon the mobile communication device MS being powered off or in accordance with a certain key operation done on the key operation unit 16 (not shown).

Incidentally, the stylus command extracting function 11-1 saves the position and the orientation of the stylus PN as the default values once at the step S102 after starting to work, as described above. The operation for saving the default values is not limited to the above, and if the position and the orientation of the stylus PN do not change at the step S103, the stylus command extracting function 11-1 can save the position and the orientation as updated default values. Further, the stylus command extracting function 11-1 can calculate an average of the position and the saved default position and an average of the orientation and the saved default orientation and can save the calculated average values as updated default values.

The movement of the stylus PN in its position and orientation at the step S103 and an example of a command according to the movement will be explained. In a first case, if the z-coordinate of the position of the stylus PN is not zero and its x-y coordinates do not change, and if options, e.g., menu items are displayed on the screen of the display unit 15, the stylus command extracting function 11-1 extracts a command such that one of the options positioned at the x-y coordinates of the stylus PN is selected.

Further, if the z-coordinate of the position of the stylus PN is not zero and its x-y coordinates change, in other words if the position of the stylus PN moves parallel to the screen, display positions of all the displayed options move, which means, e.g., that the menu items are scrolled. An option selected after scrolling is an option newly displayed at a position which was selected before the x-y coordinates change, and can be an option which was selected before the x-y coordinates change.

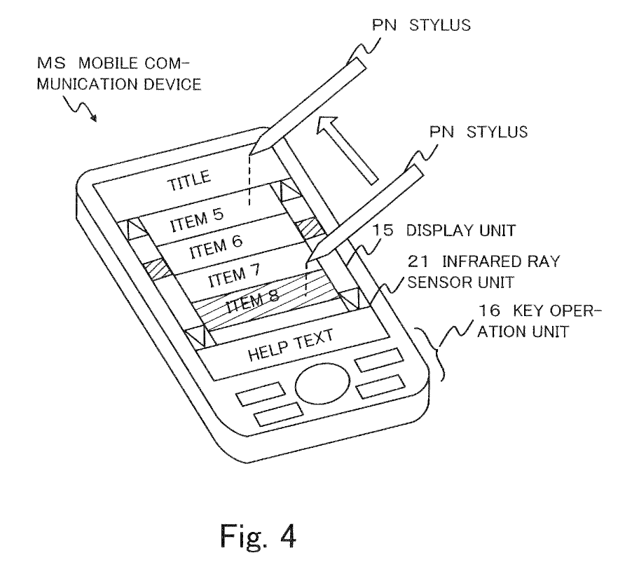

FIG. 4 shows an example of such a first extracting process. Before the x-y coordinates of the position of the stylus PN change, a menu item 5 was displayed and selected at a position where a menu item 8 is displayed in FIG. 4. If the x-y (mainly y) coordinates of the position of the stylus PN changes to an upper position shown in FIG. 4, the position where an option to be selected is displayed does not change and FIG. 4 shows that the menu items are scrolled in accordance with the change of the position. The selected item is indicated by a different indicating form such as an inverted color. The selected item is indicated by hatching in FIG. 4.

The number of scrolling steps according to this extracting process depends on the number of the items displayed on the screen, and at most three for the example shown in FIG. 4. If more scrolling steps are required, remove the tip of the stylus from a space in front of the screen once, and move the stylus back to the space in front of the screen again so as scroll the items. In order to change the selected menu item, similarly remove the tip of the stylus from the space in front of the screen once, and move the stylus to the space in front of the screen again.

Incidentally, a title and a help text of the selected menu are displayed on upper and lower sides of the screen of the display unit 15, respectively, and scroll bars are displayed on left and right sides of the screen, as it is preferable not to display the option in a fringe area of the display.

A reason why is that the stylus PN faces the display at a certain inclination. Thus, if the x-y coordinates of the position of the stylus PN is close to the fringe area and even if the infrared ray sensor unit 21 is provided in such a way as to reach the outside of the screen on the housing of the mobile communication device MS, a growing possibility of an error in accuracy of detecting the x-y coordinates of the position cannot be avoided. Thus, display no option in the fringe area of the screen, so that a bad effect caused by the error can be reduced.

Incidentally, if the stylus is held by a user's right hand, it is particularly desirable that no option should be displayed on the lower and right sides of the display. If the stylus is held by the user's left hand, it is particularly desirable that no option should be displayed on the lower and left sides of the display. Thus, the controller 11 can correct the display depending upon which of the hands the user holds the stylus PN with, such as displaying the scroll bar on either one of the right and left sides of the screen.

In a second case, if the x-y coordinates of the position of the stylus PN remain in a certain small range and the z-coordinate changes to a value smaller than a certain value and then immediately returns to a value more than the certain value, in other words if the tip of the stylus PN falls onto the screen of the display unit 15 so as to be in contact with the screen and then immediately returns to the former position, the stylus command extracting function 11-1 extracts a command such that selection of an option displayed at the position of the contact is determined. The controller 11 ordinarily performs a function indicated by the option.

In a third case, if the y-coordinate of the position of the stylus PN becomes smaller than the default value and then returns to the former value, and the x- and z-coordinates slightly changes from the default value, in other words if a user of the mobile communication device MS moves the stylus PN in such a way as to write an alphabet “v” or a predetermined locus, the stylus command extracting function 11-1 extracts a command such that selection of an option displayed at the position of the x-y coordinates is determined. The stylus command extracting function 11-1 refers to whether the user holds the stylus PN with his or her right hand or left hand. A reason why is that the movement can possibly be different depending on which of the hands the user holds the stylus PN with.

In a fourth case, if the x-coordinate of the stylus PN slightly changes from the default value and both the y- and z-coordinates become slightly more or smaller than the default value and the orientation of the stylus PN changes from the default value to a greater or smaller value, in other words if the user inclines the orientation of the stylus PN towards the upper or lower portion of the screen, the stylus command extracting function 11-1 extracts a command such that an option displayed in accordance with the change of the orientation of the stylus PN is scrolled up or down. Incidentally, a scrolling speed is made approximately in proportion to the change of the orientation of the stylus PN, and how fast it scrolls owing to what change is determined in advance or set in accordance with an input from the key operation unit 16 or the stylus input unit 20.

The stylus command extracting function 11-1 can stop extracting the command for scrolling if the stylus PN stops moving. Meanwhile, the stylus command extracting function 11-1 can continue to extract the command if the stylus PN stops moving but changes the orientation, and can stop extracting the command if the orientation returns to the former value. While continuing to extract the command, the stylus command extracting function 11-1 can make the scrolling speed slower as time passes, and can stop extracting the command for scrolling after a certain period of time passes.

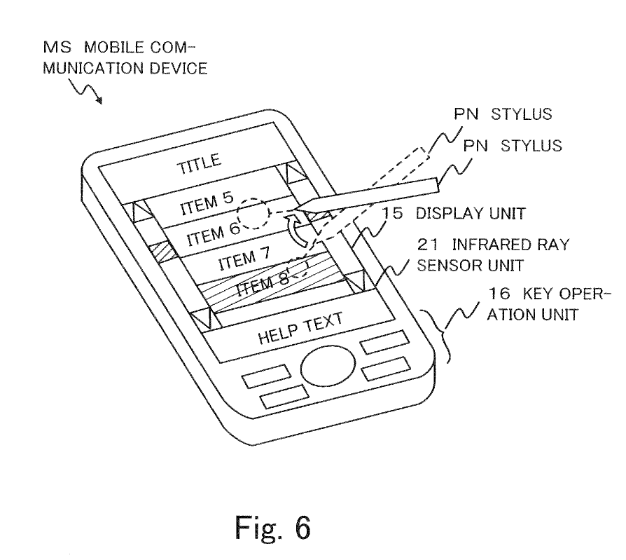

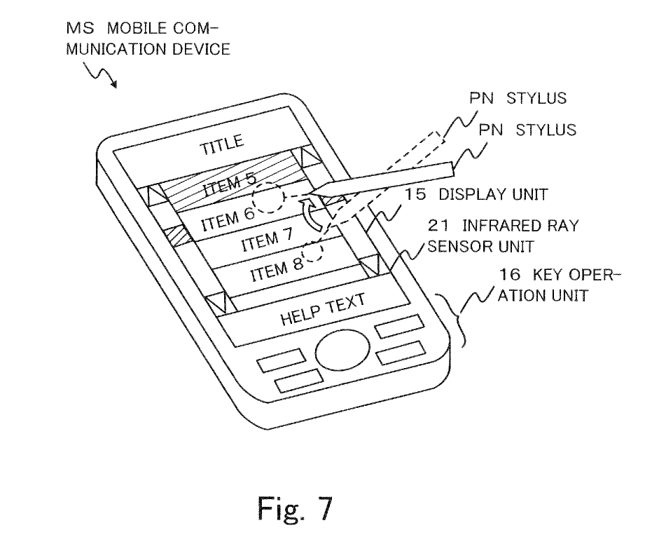

FIG. 6 shows an example of the fourth case where an option is scrolled upwards as the stylus PN is oriented to a much upper portion of the screen. The selected option is an option newly displayed at a position where an option that was selected before the operation in the fourth case was displayed. FIG. 7 shows an example such that the stylus PN similarly moves and the selected option is an option that was selected before the operation in the fourth case. In FIGS. 6 and 7, an area irradiated with the infrared rays emitted from the stylus PN is roughly indicated by a circle (to put it more exactly, not limited to a circle, as the infrared rays are shaped like a conic section).

The menu items form on the display unit 15, although not limited to, a vertical line for the example described above, and can form a horizontal line. In this case, it will be enough for the stylus command extracting function 11-1 to deal with a vertical movement of the stylus PN explained above as a horizontal movement, and to deal with a horizontal movement of the stylus PN explained above as a vertical movement. Accordingly, the stylus command extracting function 11-1 deals with a change of the x-coordinate of the position of the stylus PN as a change of the y-coordinate, and deals with a change of the y-coordinate of the position of the stylus PN as a change of the x-coordinate. Further, icons can be displayed in vertical and horizontal lines.

If the user moves the stylus PN in contact with the display screen on the display unit 15, the menu items displayed on the display screen are not scrolled. In this case, the menu item to be selected is changed over the menu items.

### Modification in Infrared Sensor Unit 21 and Stylus Position Sensor Unit 22

The infrared sensor unit 21 and stylus position sensor unit 22 can be modified to an embodiment other than what is described above. For such an embodiment, the display unit 15 is provided on the four sides with infrared ray emitting units. The infrared ray emitting unit provided on the upper side emits a plurality of or a belt-shaped infrared ray(s) towards the lower side, and so do the infrared ray emitting units provided on the lower, left and right sides towards the upper, right and left sides, respectively.

For the embodiment, a plurality of the infrared ray sensor units 21 is provided on a plurality of positions on each of the four sides of the screen of the display unit 15. The infrared ray sensor units 21 provide an output regarding at which position on the four sides and how intensely an infrared ray is sensed.

Further, if the stylus position sensor unit 22 is close to the pointer, the stylus position sensor unit 22 detects the x-y-z coordinates as the infrared ray sensed by the infrared ray sensor unit 21 is intense. Further, in a case where the infrared rays are sensed at lots of positions on one of the sides, in other words a maximum intensity value of the sensed infrared rays is insignificant and the infrared rays are sensed with the wide skirts, the stylus position sensor unit 22 detects the orientation of the pointer in an assumption that the pointer is not inclined towards the side. Further, in a case where the infrared rays are not sensed at many positions on one of the sides, in other words the maximum intensity value of the sensed infrared ray is significant and the infrared rays are sensed within a narrow range, the stylus position sensor unit 22 detects the orientation of the pointer in an assumption that the pointer is inclined towards the side.

The embodiments are applied to, although not limited to, the mobile communication device MS for the example described above, and can be applied to every data processing device including a personal computer and particularly a portable one as a matter of course. Further, the present invention can be applied to a device equipped with an input device such as a mouse in addition to the key operation unit 16 without any difficulty. The present invention is not limited to the above configuration, and can be variously modified.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A data processing device comprising:
a display unit which displays menu items;
a position sensor unit which detects an orientation of a pointer and a position of the pointer; and
an input control unit which identifies, upon the position sensor unit detecting the position of the pointer, one of the menu items as being selected, changes a display form of the menu item to be selected, and scrolls the menu items displayed on the display unit when the position sensor unit detects that the orientation of the pointer changes.

2. The data processing device according to claim 1, wherein
the position sensor unit is provided in such a way that the screen of the display unit is covered by the position sensor unit or, further, that the position sensor unit reaches the outside of the screen,
the position sensor unit receives electromagnetic waves emitted in a conical form from the tip of the pointer, and
the position sensor unit detects the orientation of the pointer and the position of the pointer depending on an intensity distribution of the received electromagnetic waves.

3. A data processing device comprising:
a display unit which displays menu items;
a position sensor unit which detects a position of a pointer by sensing a coordinate on the display unit; and
an input control unit which identifies, upon the position sensor unit detecting the position of the pointer, one of the menu items as being selected, changes a display form of the menu item to be selected, and scrolls the menu items displayed on the display unit when the position sensor unit detects that the position of the pointer changes.

4. A data processing device comprising:
a display unit which displays menu items;
a position sensor unit which detects a position of a pointer; and
an input control unit which identifies, upon the position sensor unit detecting the position of the pointer, one of the menu items as being selected, changes a display form of the menu item to be selected, and scrolls the menu items displayed on the display unit when the position sensor unit detects that the pointer follows a predetermined locus.

5. The data processing device according to claim 3, wherein
the position sensor unit is provided in such a way that the screen of the display unit is covered by the position sensor unit or, further, that the position sensor unit reaches the outside of the screen,
the position sensor unit receives electromagnetic waves emitted in a conical form from the tip of the pointer, and
the position sensor unit detects the position of the pointer depending on an intensity distribution of the received electromagnetic waves.

6. The data processing device according to claim 4, wherein
the position sensor unit is provided in such a way that the screen of the display unit is covered by the position sensor unit or, further, that the position sensor unit reaches the outside of the screen,
the position sensor unit receives electromagnetic waves emitted in a conical form from the tip of the pointer, and
the position sensor unit detects the position of the pointer depending on an intensity distribution of the received electromagnetic waves.
